(19) United States
(12) Patent Application Publication
(10) Pub. No.: US 2010/0001874 A1
(43) Pub. Date: Jan. 7, 2010

(54) REMOTE TRANSMISSION SYSTEM AND METHOD FOR DETECTING ONSET OF STRUCTURAL FAILURE

(75) Inventor: Dale O. Cipra, Chatsworth, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: PRATT & WHITNEY ROCKETDYNE, INC., Canoga Park, CA (US)

(21) Appl. No.: 12/165,695

(22) Filed: Jul. 1, 2008

(51) Int. Cl. G08B 21/02

(52) U.S. Cl. 340/683

(57) ABSTRACT

A method for monitoring a structure subject to a mechanical load comprises measuring physical parameters associated with natural oscillations of the structure, transforming the physical parameters into normal mode spectra, and broadcasting an alarm as a function of a change in the normal mode spectra near a critical point. The normal mode spectra represent the natural oscillations of the structure.

### CROSS-REFERENCE TO RELATED APPLICATION

This application is related to co-pending U.S. patent application Ser. No. 11/699,945, entitled SYSTEM AND METHOD FOR DETECTING ONSET OF STRUCTURAL FAILURE, filed Jan. 30, 2007 by Dale O. Cipra and of common assignee.

### BACKGROUND

This disclosure relates generally to structural testing and structural monitoring. In particular, the disclosure concerns detecting the onset of structural failure by analysis of normal mode oscillations.

Structural failure can be unpredictable and catastrophic, posing both financial risks and a threat to personal and public safety. Traditional destructive testing techniques are effective at determining a failure threshold, but do not generally detect the onset of failure before it occurs. As a result, safety margins must be determined a priori or by trial and error.

During testing, unknown critical points and unanticipated failure modes can pose significant safety hazards, and result in substantial economic losses. Post-testing failures (i.e., during construction or use) are also potentially serious, and difficult to predict. This is particularly true for large-scale structures such as buildings and bridges, which are subject to highly variable mechanical loads and exposed to long-term environmental effects that can degrade structural integrity.

Structural inspections address some of these concerns, but typical inspection techniques suffer from limited accessibility and require significant time and expertise. This forces an economic tradeoff between thoroughness and cost, resulting in inspection cycles that are at best periodic, and sometimes occur only after a significant event such as earthquake, fire, or accident. Traditional visual inspection techniques, moreover, are quite different from those employed during structural testing, making correlations between the two approaches difficult and further compromising the ability to detect the onset of structural failure before it actually occurs.

Structural health monitoring (SHM) systems address some of these concerns. SHM systems employ a variety of sensing and measurement technology, utilizing generally small, remotely-operated sensors. These provide information on position, temperature, and other physical quantities, and allow for continuous monitoring methods to be employed in otherwise inaccessible locations. Some SHM systems also employ active transducers, including ultrasonic piezoelectric devices, to “interrogate” a structure or material in order to detect displacement, delamination, cracking, or other local failures via the resulting change in Lamb wave transmissions. Existing SHM methods remain limited, however, because they do not typically apply the same sampling and analysis techniques used during structural testing, and because they cannot generally detect the onset of failure before it actually occurs, at least one a local scale.

### SUMMARY

There is disclosed a system and method for detecting the onset of failure in a structural element subject to a mechanical load. The method comprises measuring physical quantities, transforming the measured physical quantities into a normal mode spectrum, and transmitting a warning of impending collapse. The measured physical quantities are associated with subsonic modes of natural oscillation in a structure subject to a mechanical load. The normal mode spectrum characterizes the frequencies of the subsonic modes of oscillation. The warning is transmitted as a function of a deviation in the normal mode spectrum near a critical point.

The system comprises a sensor, a signal processor and a transmitter. The sensor senses a physical parameter associated with a normal mode of natural oscillation in the structural element. The signal processor transforms the physical parameter into an oscillation function representing the normal mode. The transmitter transmits an alarm based on a shift in the oscillation function near a critical point.

### BRIEF DESCRIPTION OF THE DRAWINGS

FIG. 1 is a perspective view of a vertical cantilevered beam subject to a compressive load.

FIG. 2 is a plot of oscillation frequency as a function of cantilever length, neglecting the effect of load on frequency.

FIG. 3 is an enlarged view of FIG. 2, showing the effect of load on frequency near critical length.

FIG. 4 is a plot of oscillation period as a function of cantilever length, showing the effect of load on natural period of oscillation.

FIG. 5 is a plot of oscillation period as a function of compressive load, showing the effect of load on natural period of oscillation.

FIG. 6 is a block diagram of a system for detecting the onset of failure in a structural element subject to a mechanical load.

FIG. 7 is a flowchart showing a method for structural health monitoring.

### DETAILED DESCRIPTION

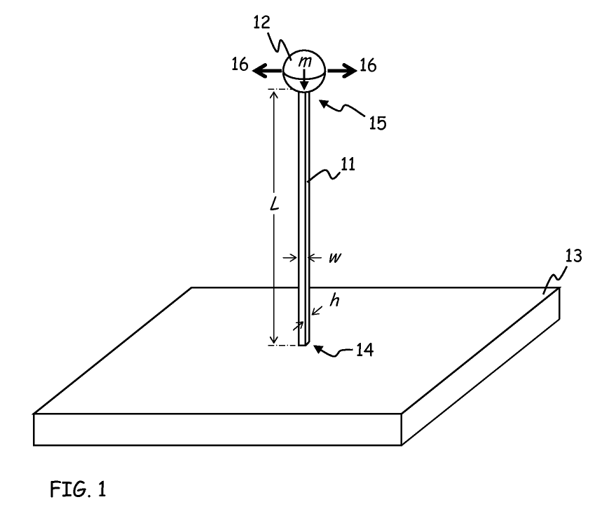

FIG. 1 is a perspective view of vertical cantilevered beam 11 subject to compressive load 12. FIG. 1 shows cantilevered beam 11 of length L with transverse dimensions h and w, loading mass 12 with mass m, and substantially immobile base 13. Beam 11 is vertically oriented, with lower end 14 of beam 11 affixed to base 13, and upper end 15 of beam 11 affixed to loading mass 12. Beam 11 is a structural element with relatively small mass as compared to mass m of loading mass 12, and loading mass 12 represents a mechanical load directed toward a relatively small region of beam 11 as compared to length L.

In this arrangement, loading mass 12 and upper end 15 of beam 11 are susceptible to small-amplitude oscillations generally oriented in a horizontal plane that is substantially parallel to base 13. Arrows 16 indicate one possible sense (or mode) of this natural oscillation. This mode is spring-like, with natural frequency f determined by effective spring constant k and mass m:

$$f = \frac{1}{2 π} \sqrt{\frac{k}{m}} . \qquad [ 1 ]$$

In general, Eq. 1 describes any of a number of naturally-occurring modes of oscillation in the structure, which can be characterized by a natural mode frequency (alternatively, a natural mode period) and amplitude. Natural mode frequencies are a function of the mechanical properties of the structure, rather than the characteristics of an external (active) mechanical oscillator such as a piezoelectric transducer.

The effective spring constant k characterizes the stiffness of the beam. For a vertically cantilevered beam the spring constant is

$$k = 3 \frac{EI}{{L}^{3}} , \qquad [ 2 ]$$

where E is Young's modulus, I is the second moment of area, and L is the length of the beam.

Young's modulus is also known as the elastic modulus. It characterizes the intrinsic stiffness of the material from which the beam is made, and has units of pressure. Young's modulus ranges from about 11 GPa (11×10⁹ pascal) for oak and other structural wood materials to just under 70 GPa for aluminum, and from approximately 190-210 GPa for iron and steel alloys.

Beam geometry contributes independently to the stiffness via the second moment of area I, also known as the area moment of inertia. For a rectangular beam the second moment of area I is determined by the beam's cross-sectional dimensions:

$$I = \frac{{wh}^{3}}{12} . \qquad [ 3 ]$$

In general, w is measured perpendicularly to the direction of oscillation and h is measured parallel to it. For a horizontal cantilever with oscillations in a generally vertical plane, h is simply the height of the beam and w is the width. For the vertical cantilever orientation of FIG. 1, both h and w are measured horizontally, and are distinguished on the basis of the mode of oscillation. That is, the direction perpendicular to the oscillation is the width (w), and the direction along the oscillation is the height (h). Typical oscillations occur in more than one direction (that is, they comprise a superposition of modes), but at small amplitude these can generally be decomposed because the response is substantially linear.

Combining Eqs. 1-3, the natural frequency of oscillation f for a vertical cantilevered beam of length L with Young's modulus E and rectangular dimensions w and h, supporting mass m, is:

$$f = \frac{1}{4 π} \sqrt{\frac{{Ewh}^{3}}{m {L}^{3}}} . \qquad [ 4 ]$$

EQ. 4 characterizes the natural frequency of small-amplitude, generally horizontal oscillations of loading mass 12 and upper end 15 of vertical cantilevered beam 11, where the beam has small mass compared with loading mass m and the loading mass has small dimensions compared with beam length L. Eq. 4 is also representative of the natural frequency of oscillation for a wide range of other structures, where mass m represents a generalized mechanical load, beam length L represents a generalized structural dimension, and k represents a generalized (effective) spring constant.

While Eq. 4 is formulated by assuming small oscillations, the model is nonetheless useful in predicting larger-scale motions associated with structural failure. In particular, Eq. 4 provides a general predictive basis for a wide range of structural oscillations, in which the onset of failure is indicated by load-dependent shifts or changes in the observed oscillation response, as described immediately below.

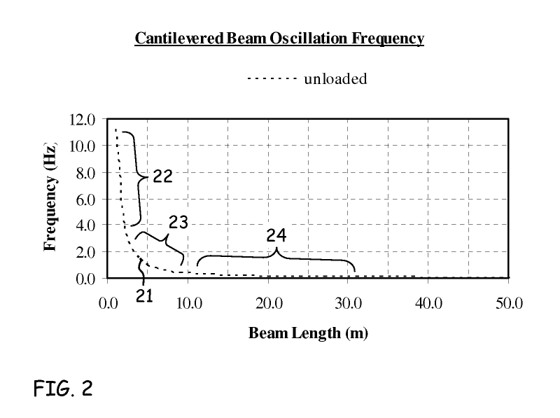

FIG. 2 is a plot of oscillation frequency as a function of cantilever length, neglecting the effect of load on frequency. In this particular example, beam 11 has Young's modulus E=200 GPa and a square rectangular cross section, with width w and height h each equal to ten centimeters (0.10 m, or about four inches). Beam 11 further supports mass m=1,000 kg, which provides a compressive load of about 9.8 kN (that is, the load is imposed by supporting a metric or long ton, which weighs about 2,200 lbs).

FIG. 2 shows unloaded frequency curve 21, which represents the oscillation frequency as a function of beam length, without taking loading effects into account. Curve 21 varies relatively smoothly (or substantially continuously) with length over the displayed domain. In particular, the frequency curve falls relatively rapidly through short-beam region 22 (from f>10 Hz for L=1 m to f<1.0 Hz for L=10.0 m), then more slowly through intermediate-length region 23 until it approaches an asymptotic value of f=0.0 Hz in asymptotic region 24, where L increases arbitrarily.

Real beams, of course, do not exhibit this smooth approach to asymptotic behavior. Instead, the observed frequency departs from unloaded curve 21 as length L approaches a critical point or critical value, signaling the onset of structural failure.

In the particular case of FIG. 2, the structural failure is a buckling failure. This occurs when the beam can no longer support oscillations of the load, and it collapses. Buckling failures are particularly problematic because they are difficult to predict using standard techniques, and because they have potentially disastrous structural consequences. Nonetheless, buckling failures are only one of the failure modes described herein. More broadly, a shift or divergence in the loaded oscillation curve indicates the onset of a range of different failure modes, including not only buckling failures but also shear failures, torsion failures, fatigue failures, temperature-related failures, and other more general forms of mechanical failure or structural collapse.

In addition, while FIG. 2 characterizes a fundamental mode of oscillation (with the lowest natural oscillation frequency), the analysis is also applicable to other modes. In general, the oscillations of concern comprise a combination of fundamental (lowest frequency) modes and other lower-order modes, with typical mode numbers on the order of ten or less and typical frequencies on the order of ten times the fundamental frequency or less. This specifically includes fundamental modes and lower-order modes in relatively large structural elements, such as I-beams, girders, bridge supports and the like, in which the relevant natural frequencies of oscillation are subsonic.

Other embodiments concern oscillations of smaller structural elements or elements with high effective spring constants, which sometimes extend into a lower end of the audio range (that is, below approximately 100 Hz). This distinguishes from higher-order audio-frequency techniques, where the mode number is typically higher and the frequency range extends into an intermediate audio range (above 100 Hz). This further distinguishes from high-frequency techniques, including, but not limited to, Lamb wave techniques and electromechanical impedance or induction-based techniques, where the relevant frequency range extends to higher audio frequencies (above 1 kHz), or to an ultrasonic range (above 10 kHz or above 20 kHz).

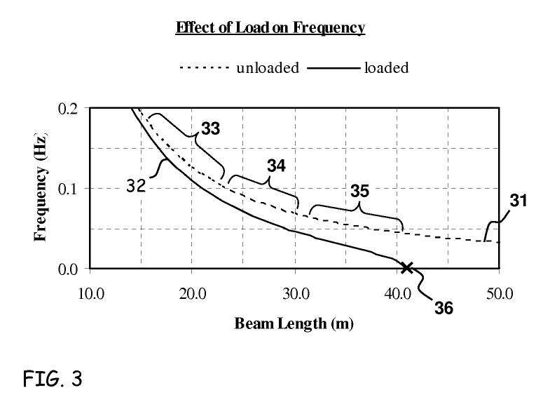

FIG. 3 is an enlarged view of FIG. 2, showing the effect of load on frequency near critical length. The figure shows both unloaded frequency curve 31 (representing unloaded frequency f) and more realistic mechanically loaded curve 32 (representing loaded frequency f₁).

Unloaded oscillation function (frequency curve) 31 agrees relatively well with loaded oscillation function 32 through region of agreement 33, where L<20 m, but the curves separate in intermediate region 34 and diverge in region 35, where L>30 m. At critical point 36, loaded curve 32 drops to zero, indicating failure, whereas the idealized or unloaded curve 31 continues to approach zero asymptotically, as described above with respect to FIG. 1.

The difference between unloaded frequency f and more realistic or loaded frequency f₁ is characterized by the ratio of loading force F to critical load F_{C}, which is:

$${f}_{l} = f \sqrt{1 - \frac{F}{{F}_{C}}} . \qquad [ 5 ]$$

The loading force is the gravitational force F=mg on loading mass m, and the critical load is given by Euler's formula in terms of Young's modulus E, second moment of area I, and length L:

$${F}_{C} = \frac{EI {π}^{2}}{{L}^{2}} . \qquad [ 6 ]$$

For any given load, Euler's formula (EQ. 6) yields critical length L_{C}, which is the length at which the load becomes critical; that is, where the load is sufficient to cause a buckling or other structural failure. For gravitational load mg, for example, the critical length is:

$${L}_{C} = π \sqrt{\frac{EI}{mg}} . \qquad [ 7 ]$$

More specifically, when L=L_{C} the loading force (mg) equals the critical force (F_{C} in Eq. 6), for which Eq. 5 yields zero frequency. Accordingly, there are no longer real solutions for L>L_{C}, indicating structural failure.

Note that both natural frequency curve 31 and loaded curve 32 account for loading mass m via the natural frequency equation (EQ. 1). The divergence between the two functions arises because loaded curve 32 also accounts for the compressive (gravitational) load on the beam, which has an independent effect on the frequency via Eq. 5.

The loading effect is small in region 33, far from criticality, but increases near the critical point. Specifically, loaded oscillation curve 32 exhibits a shift or change in transition region 33, which increases in magnitude through diverging region 34 until loaded frequency curve 32 diverges abruptly toward zero at critical point 36.

More general loading forces yield the same result. That is, regardless of failure mode, the loaded frequency f₁ goes rapidly to zero when the load becomes critical, and there are no real solutions for F>F_{C}. Thus the technique applies not only to compressive loads and buckling failures, but also to more general stress, strain, tension, torsion, pressure, or other mechanical loads, and more generalized failure modes.

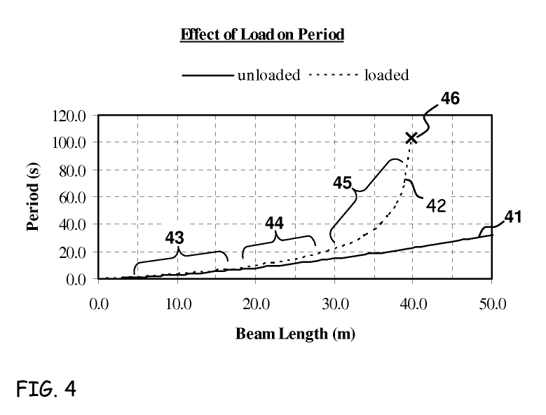

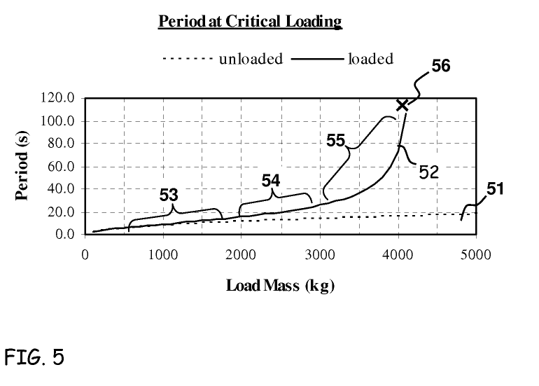

Moreover, while FIG. 3 represents the loaded oscillation function as a natural frequency curve, a range of other oscillation functions are also employable. In other embodiments, for example, loaded oscillation function 32 variously comprises a frequency curve (as shown in FIG. 3), a period curve (see FIGS. 4 and 5) or an amplitude curve, or a derivative or integral thereof.

In general, a system approaches criticality (that is, a critical point) when the slope of a sample function describing the system approaches zero, or when the function becomes undifferentiable (that is, the slope of the function goes to zero, or becomes unbounded or undefined as the function approaches the critical point). This includes points where the value of the function (e.g., a frequency or period) approaches an unbounded value. In particular, it includes points where the frequency approaches a value of zero, because the period becomes undefined at such points (see FIG. 4).

The approach to a critical point contrasts with the approach to an asymptotic value. In FIG. 2, for instance, the oscillation function (the frequency) has a continuously-defined non-zero value for all real cantilever lengths L. Thus the frequency does not approach zero until the functional parameter (cantilever length) approaches an unbounded value. For critical point 36 of FIG. 3, on the other hand, loaded oscillation curve 32 goes abruptly to zero while the functional parameter (cantilever length) is still finite.

Similarly, unloaded oscillation function (frequency curve) 21 of FIG. 2 is continuously differentiable, and the slope remains non-zero for all real cantilever lengths L. Loaded frequency curve 31 of FIG. 3, in contrast, becomes undifferentiable when the oscillation function approaches a finite critical point (critical length L_{C}≈41 m), where the slope approaches an unbounded (negative) value. For other functions the slope approaches zero near the critical point, or, alternatively, the slope approaches an unbounded positive value (see, e.g., FIG. 4, immediately below). Alternatively the slope is nominally finite but nonetheless undefined, such as at a cusp point.

FIG. 4 is a plot of oscillation period as a function of cantilever length, showing the effect of load on the natural period of oscillation. FIG. 4 shows unloaded curve 41 and loaded curve 42, which are the inverses of frequency curves 31 and 32, respectively (that is, the unloaded period of oscillation is T=1/f, and the loaded period is T₁=1/f₁). The beam is a steel alloy beam with the similar characteristics described above with respect to FIG. 2.

As in the frequency plot of FIG. 3, period curves 41 and 42 exhibit a region of similar behavior 43, then pass through intermediate region 44 and diverging region 45 as the curves approach critical point 46. In contrast to FIG. 3, however, loaded period curve 42 approaches an unbounded value (becomes undefined) at critical point 46, rather than approaching a zero value as for loaded frequency curve 32.

While the underlying mathematics are the same for frequency and period analysis, the period (or inverse) analysis sometimes more clearly illustrates the fundamentally different behavior of unloaded curve 41 and loaded curve 42 in the approach to criticality. As described above, this behavior applies to a wide range of normal mode oscillation functions.

In addition, while FIGS. 3 and 4 represent particular modes of oscillation (specifically, fundamental modes), a more general analysis comprises a number of different oscillation modes. In the more general analysis, physical measurements are transformed into a normal mode spectrum (or series of sample mode spectra). These represent a number of different oscillation functions, each corresponding to a different normal mode of oscillation. Typically, the mode spectra include a fundamental oscillation and other lower-order modes, which are expressed in terms of position, velocity, acceleration and angle. In some embodiments, the oscillation curves represent more generalized oscillations in stress, strain, tension, torsion, temperature, pressure, or another load-related physical quantity.

As the system nears a critical point, the slope of one or more loaded oscillation curves approaches zero or an indeterminate value, and the curve diverges from the unloaded model. This shift or variation in the oscillation function shows that the mechanical behavior of the structure is changing, which in turn indicates the potential for a structural failure. By looking for these signatures of criticality in a number of different modes, as represented by the oscillation functions, it is possible to detect the onset of structural failure before it actually occurs.

In general, a number of different changes in the oscillation function indicate the onset of structural failure. At the critical point, the slope approaches zero or becomes undefined. Depending upon the nature of the critical point, the value of the function itself sometimes approaches become zero or becomes undefined as well. Any of these changes in the oscillation function indicates the onset of structural failure near the critical point (that is, the approach to criticality).

Alternatively, the onset of structural failure is signaled by the departure of the measured oscillation function from an analytical model, where the departure results from the approach to a critical point, which shifts the oscillation function (or its slope) away from the model. In the general case, moreover, the shifts occur in any one of a number of relatively low-order oscillation modes, or in an oscillation spectrum representing a number of such modes.

The magnitude of the shift or change required to issue a failure warning (or structural collapse alarm) depends upon the particular system in question. In some embodiments, alarm thresholds are determined as a fraction of a natural oscillation frequency, such as a shift of ten percent, twenty percent, fifty percent or more in a lowest-order oscillation frequency, or another relatively low-order oscillation frequency. Alternatively, alarm thresholds are defined in terms of oscillation period, rather than frequency.

The alarm threshold is also a function of the accuracy of the measurement and modeling process. In some embodiments, for example, the threshold is a variance or other statistical departure from an analytical model, such as a one-sigma or three-sigma departure from an analytically predicted frequency or period, or from an analytically predicted slope of a frequency or period curve. In these embodiments, “sigma” represents a standard statistical measure such as a standard deviation or standard deviation of a mean, as determined from a series of oscillation measurements.

In each of these embodiments, the relevant shift or departure arises in the approach to criticality, rather than at criticality itself. That is, the onset of structural failure is detected near the critical point, but before structural failure actually occurs. The relevant detection region is close or near enough to the critical point for departures in the oscillation function (or spectrum) to reach an alarm threshold, but far enough from the critical point to generate a warning or alarm with sufficient safety margin to allow evacuation of the structure, or to perform other remedial or preventative actions before failure actually occurs.

In some embodiments, the onset of structural failure is also detected before its local manifestations are expressed; that is, before local failures occur, such as cracking or delamination in a composite structure such as a rotor, or the loss of individual mechanical fastenings such as rivets, bolts, weld points, or the failure of individual gusset plates. This distinguishes from Lamb wave and impedance-based techniques that rely on local failure modes as a primary indicator, or which are otherwise not substantially sensitive to the onset of failure in a composite structure until some of its individual (local) components have already been compromised or irreversibly damaged.

FIG. 5 is a plot of oscillation period as a function of compressive load, showing the effect of load on natural period of oscillation. FIG. 5 shows natural oscillation curve 51 and loaded curve 52, for a beam with fixed length L=10 m, variable loading mass m, and other characteristics as described with respect to FIG. 2, above.

Natural oscillation curve 51 and loaded curve 52 again pass through similar region 51, transition region 52, and strongly diverging region 53 before reaching critical point 56. In FIG. 5, however, the divergence depends directly upon loading mass m, not indirectly upon length L.

FIGS. 3-5 illustrate a broad capability to detect the onset of structural failure, whether due to changes in the mechanical load or due to changes in load-related dimensions such as cantilever length. These methods are also sensitive to changes in environmental parameters such as temperature, which affect the oscillation curves by changing the mechanical properties of the structure. In general, therefore, oscillation curves are represented in terms of a range of different functional parameters, including not only time but also force, mass, pressure, length, temperature, humidity and other parameters. Further, some oscillation curves represent other physical quantities related to the mechanical load, such as stress and strain.

These techniques are applied to three general classes of structural elements. In the first class, the unloaded oscillation curve is analytically modeled, but the loaded behavior and failure points are unknown. In this class, the loaded curves are empirically measured, and the characteristic signal of structural failure is a substantial departure (that is a shift, deviation, change or variation) from the unloaded oscillation model, as the function approaches a critical point. While the critical points themselves are in principle unknown, careful analysis of the loaded (measured) response provides a quantitative estimate, as obtained, for example, by inverting Eq. 5.

In the second class, both the natural frequency and failure points (critical points) are known, providing an analytical model for both natural and loaded curves. In this class the onset of structural failure is signaled by a departure from the (predicted) unloaded curve, along the (also predicted) loaded curve.

In some cases, the observed oscillation curve departs from both the unloaded model and from the loaded model, indicating the onset of an unexpected failure mode. Unexpected failure modes are due to any of a wide range of potential causes, including, but not limited to, design defects, manufacturing defects, improper construction or maintenance, unanticipated loading conditions, erosion, corrosion and extreme temperatures.

The third class covers structural elements for which no sufficiently predictive analytical model exists. This class includes composite structural elements made up of a large number of individual structural elements, structural elements of unknown construction or composition, or complex structural elements resistant to an analytical approach. The slope of the loaded curve will nonetheless become unbounded as the structural element approaches criticality. This behavior indicates the onset of structural failure, even when no analytical model is available.

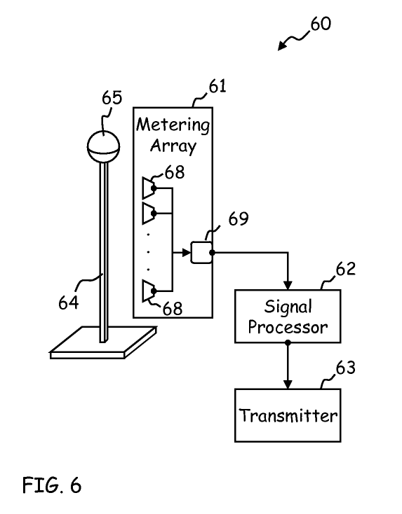

FIG. 6 is a block diagram of system 60 for detecting the onset of failure in a structural element subject to a mechanical load. System 60 comprises metering array 61, signal processor 62 and transmitter 63.

Metering array 61 comprises one or more sensor elements 66. Sensor elements 66 include, but are not limited to, position sensors, velocity sensors, accelerometers, angular sensors, stress gauges, strain gauges, subsonic sensors, audio sensors, ultrasonic sensors, laser vibrometers, optical sensors, temperature sensors, pressure sensors and other sensing elements.

Sensor elements 66 sense the physical parameters associated with oscillations of structural element 64, and generate sensor signals that characterize these physical parameters. Sensors 66 sense a range of parameters including, but not limited to, time, position, velocity, acceleration, angle, length, weight, force, pressure, tension, torsion, stress, strain, temperature and humidity.

Metering array 61 measures the physical parameters sensed by sensor elements 66, by conditioning the sensor signals and converting to physical measurements. Typically, metering array 61 utilizes calibrated conversion functions appropriate to each different sensor element 66. In some embodiments, metering array 61 accomplishes signal conditioning and conversion utilizing via interface 67, which comprises a number of amplifier, preamplifier, A/D (analog to digital), D/A (digital to analog) and other electronic components. In this embodiment, metering array 61 communicates the measured physical quantities to signal processor 62 via interface 67.

In other embodiments, sensor elements 66 comprise analogous components to perform the signal conditioning and conversion functions. In these embodiments, sensor elements 66 sometimes communicate directly with signal processor 62, without interface 67.

Signal processor 62 comprises a signal transform function for transforming measured physical quantities from metering array 61 into oscillation functions (oscillation curves) that represent the normal modes of oscillation. The oscillations are represented as functions of time, mechanical load or related parameters, as sensed by sensor elements 66 and measured by metering array 61.

In typical embodiments, signal processor 62 further transforms the measured physical quantities into a number of normal mode spectra, each comprising a number of different individual oscillation functions. The different oscillation functions represent different modes of oscillation, or represent the modes in terms of different functional parameters.

Transmitter 63 comprises a transmitter for generating an output as a function of the sample mode spectra and oscillation functions. Typically, the output comprises a signal, warning or alarm that is generated when one of the oscillation functions shifts or changes near a critical point, indicating the onset of structural failure as described above.

Structural element 64 is representative of a range of structural elements including beams, I-beams, posts, girders, box girders, pipes, walls, pressure vessels, hulls, vanes, blades, housings and other structural elements. Structural element 64 also represents composite structures comprising a number of different individual elements, such as a building or bridge. Alternatively, structural element 64 represents a helicopter, fixed-wing aircraft, ship, trucks, tank, or other vehicle.

Structural element 64 is subject to mechanical load 65. Mechanical load 65 is a compressive load or a more general stress, strain, tension, torsion, pressure, or other mechanical load, or a combination of such loads. In some embodiments, mechanical load 65 is a substantially constant mechanical load. In other embodiments, mechanical load 65 is variable.

While FIG. 6 describes metering array 61, signal processor 62 and transmitter 63 individually, this example is merely illustrative. In typical embodiments, these elements share physical or hardware components, and their functions overlap. In one embodiment, for example, signal processor 62 comprises a central processor, such as a microprocessor or computer, which also performs signal conditioning and signal conversion functions for sensors 66 and metering array 61, or transmitter control functions for transmitter 63, or both. In other embodiments, system 60 utilizes a number of different processing components, and these functions are divided.

In operation of system 60, metering array 61 with sensor elements 62 is positioned for measuring physical quantities associated with normal mode oscillations of structural element 64, when subject to mechanical load 65. The oscillations are naturally occurring normal mode oscillations of structural element 64, as described above.

Natural oscillations of structural element 64 are typically environmentally induced, or incidentally induced by human activity related to structural element 64 and load 65. The natural oscillations include modes that are induced, for example, by wind or wave action, or by transportation across a bridge, occupying a building, or by driving or piloting a vehicle. The natural oscillations do not, however, include active-interrogation based oscillations, such as Lamb-wave oscillations induced by active transducers.

The natural oscillations exhibit normal mode frequencies that are characteristic of structural element 64. In typical embodiments, these modes comprise fundamental and other lower-order modes with mode numbers on the order of ten or less. These natural oscillations typically occur in the subsonic and low-audio range, below about one hundred hertz (100 Hz), and do not typically extend to the higher frequency range of one thousand hertz (1 kHz) and above, as characteristic of Lamb wave and related impedance-based or induction-based techniques. In some embodiments, however, the relevant frequency range includes a naturally-occurring higher-frequency mode, such as a fundamental or lower-order mode of a small structural element with a high effective spring constant.

Metering array 61 communicates with signal processor 62 via transmission wires, cables, digital data buses, wireless radio-frequency (RF) systems, infrared systems, optical systems, or other communication means. In some embodiments, communication between metering array 61 and signal processor 62 is bi-directional. In further embodiments, one or both of metering array 61 and signal processor 62 typically comprises a sensor controller to control a set of sensor sampling characteristics including, but not limited to, scale sensitivity, period, integration time, and transformation window. The sampling characteristics are controlled in order to increase sensitivity to the onset of structural failure via calibration of the sensor array, as described below.

Signal processor 62 transforms measurements from metering array 61 into oscillation functions (oscillation curves) and normal mode spectra (sample mode spectra) comprising a number of different oscillation functions. In one embodiment, signal processor 62 utilizes a fast Fourier transform or related Fourier algorithm. In other embodiments signal processor 62 utilizes a more general transform such as a wavelet transform.

Signal processor 62 also transforms measured quantities from metering array 61 into functional parameters such as time, or load-related parameters such as force, stress, or strain. The oscillation functions are represented in terms of the functional parameters, as described above. Typically, the physical parameters are obtained via an averaging transform, based on a number of different individual measurements.

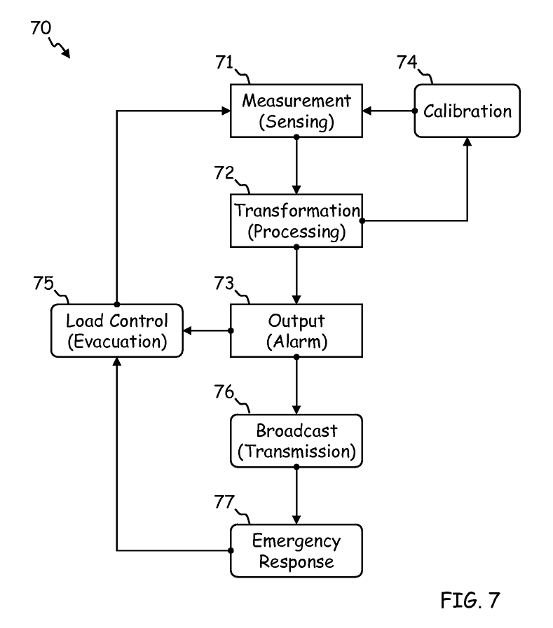

In some embodiments, signal processor 62 transforms an initial or calibration set of measurements from metering array 61 into a series of calibration curves and spectra, in order to improve the sensitivity of system 60 to the onset of structural failure. In particular, the calibration curves and calibration spectra are used to determine appropriate sampling parameters, as described with respect to calibration (step 74) of FIG. 7, below.

Transmitter 63 comprises an output processor to generate an output indicating the onset of structural failure. The output typically comprises a digital signal representing the oscillation functions and normal mode spectra. The output also comprises a warning signal or alarm, which indicates the onset of structural failure near a critical point. The warning signal or alarm is based on a shift or change in a normal mode spectrum or oscillation function, as described above with respect to FIGS. 2-5.

In some embodiments, the alarm comprises a visual or audible alarm. In further embodiments, transmitter 63 comprises a commercial off-the-shelf (COTS) wireless transmitter, such as a battery-powered autonomous wireless transmitter (AWT), a web-based transmitter linked to the internet, or a phone-based transmitter such as a cellular phone. In these embodiments, the alarm output comprises a wireless electronic mail or other wireless electronic message, a phone call, a radio-frequency broadcast or other wireless transmission.

FIG. 7 is a flowchart showing method 70 for structural health monitoring (SHM). SHM method 70 comprises measurement (step 71) of physical quantities associated with normal mode oscillations in a structural element, transformation (step 72) of the measured physical quantities into functions representing oscillations, and output (step 73) of a signal indicating the onset of structural failure.

In some embodiments, SHM method 70 comprises calibration (step 74) for improving sensitivity to the onset of structural failure. In additional embodiments, method 70 further comprises load control (step 75) for controlling the load on the structural element, in order to prevent failure. In further embodiments, load control is accomplished via broadcasting an alarm signal (step 76) and emergency response (step 77).

Measurement (step 71) comprises measurement of position, velocity, acceleration, angle, stress, strain, tension, torsion, vibrational frequency, temperature, pressure, or other physical quantity associated with the structural element. The measured quantities are typically provided via sensors and a metering array, such as sensors 66 and metering array 61 of FIG. 6, above.

Transformation (step 72) comprises transformation of the measured quantities into a number of oscillation functions and normal mode spectra. Transformation is typically accomplished via a signal processor such as signal processor 62 of FIG. 6, above.

In one particular embodiment, transformation (step 72) comprises a fast Fourier transform of accelerometer measurements relevant to low-frequency (les than 100 Hz) normal mode oscillations. In this embodiment method 70 typically employs a set of sampling characteristics including a sampling period of less than one second, preferentially on the order of hundredths of seconds, a scale sensitivity dependent upon the amplitude of oscillation, and a transformation window spanning at least one oscillation cycle, preferentially a number of cycles.

Output (step 73) comprises generation of output indicative of the onset of structural failure. In typical embodiments, output (step 73) is accomplished via a transmitter or output processor, as described above with respect to transmitter 63 of FIG. 6.

SHM method 70 is generally directed toward a structural element or composite structure such as a lifting apparatus, crane, bridge, building, or other structure, or a vehicle such as a naval vessel, truck, tank, helicopter, or fixed-wing aircraft. In some embodiments, the composite structure is a prototype for testing purposes, and in other embodiments the composite structure is a production model subject to the particular use for which it is designed, such as flight, construction, or road or rail transportation.

SHM method 70 sometimes comprises calibration (step 74). Calibration is typically performed over a series of initial applications of method 70. In these embodiments, transformation (step 72) is utilized to produce a number of baseline oscillation curves and baseline spectra for calibration purposes. The baseline data are used to determine the characteristic naturally-induced normal mode oscillation frequencies and amplitudes, and to adjust the sampling parameters (in particular, scale sensitivity and transformation window). This increases sensitivity to the onset of structural failure by increasing response to changes or shifts in the oscillation functions and normal mode spectra when approaching critical points.

In some embodiments, calibration (step 74) comprises a combination of destructive and non-destructive testing of individual structural elements. This further increases sensitivity, by providing analytical models for comparison with loaded oscillation curves, using the same methods applied during actual use of the structure, apparatus, or vehicle. Calibration is particularly valuable for structures exposed to highly variable loads or adverse environmental effects such as corrosion, erosion and temperature extremes, which can alter the structure's mechanical response to normal mode oscillations.

In embodiments directed toward bridges, buildings and other infrastructure, or to large vehicles, SHM method 70 typically comprises load control or evacuation (step 75). Load control/evacuation (step 75) is designed to provide a load reduction when output (step 73) raises an alarm that indicates impending structural failure.

In one embodiment, the impending structural failure alarm corresponds to a significant change in an oscillation mode, such as a significant shift toward zero frequency in the fundamental mode frequency of bridge, building, or large structural component of an aircraft, ship or vehicle. Such shifts are variously caused, for example, by the corrosion, weakening, or improper design of a structural member such as a wing, rotary blade, beam, box girder, rivet, weld, bolt, or gusset plate, or by an unanticipated or unusually heavy mechanical load, or by a combination of such effects

Load control/evacuation (step 75) is typically accomplished by an output processor or transmitter/broadcast device, as described above with respect to transmitter 63 of FIG. 6. Load control (step 75) is accomplished either directly, via output/alarm (step 73), or indirectly, via broadcast/transmission (step 76) and emergency response (step 77). Alternatively, load control (step 75) is accomplished by a combination of direct and indirect means.

In direct control embodiments, load control (step 75) is accomplished via an audio or visual alarm, such as a red light, warning bell or warning gate directing traffic or persons to stay off or evacuate a bridge, vehicle, or other structure. In some of these embodiments, the alarm comprises a signal such as a gate closure signal to physically prevent traffic from entering a bridge or other transportation-related structure. In these embodiments, the alarm is sometimes directed to one or more of a toll booth, a toll plaza, or a control station for a drawbridge, lift bridge or other mechanically operated structure.

In indirect load control embodiments, evacuation is accomplished via broadcast or transmission (step 76) to emergency response personnel, who accomplish load control (step 75) by emergency response (step 77). This embodiment is particularly valuable for larger-scale structures such as bridges and buildings occupied by untrained or civilian personnel, where on-site personnel are required for safe evacuation.

Although the present invention has been described with reference to preferred embodiments, the terminology used is for the purposes of description, not limitation. Workers skilled in the art will recognize that changes may be made in form and detail without departing from the spirit and scope of the invention.

1. A method for monitoring a structure subject to a mechanical load, the method comprising:
measuring physical parameters associated with natural oscillations of the structure when subject to the mechanical load;
transforming the physical parameters into a normal mode spectrum, such that the normal mode spectrum represents the natural oscillations of the structure; and
broadcasting a structural failure alarm as a function of a change in the normal mode spectrum near a critical point.

2. The method of claim 1, wherein transforming the physical parameters into the normal mode spectrum comprises transforming the physical parameters such that the normal mode spectrum represents a natural mode of oscillation having a frequency of less than one hundred hertz.

3. The method of claim 1, wherein transforming the physical parameters into the normal mode spectrum comprises transforming the physical parameters such that the normal mode spectrum represents a natural mode of oscillation having a subsonic frequency.

4. The method of claim 1, wherein transforming the physical parameters into the normal mode spectrum comprises transforming the physical parameters such that the normal mode spectrum represents a natural mode of oscillation having an order of less than ten.

5. The method of claim 1, wherein transforming the physical parameters into the normal mode spectrum comprises transforming the physical parameters such that the normal mode spectrum represents a fundamental mode of oscillation.

6. The method of claim 1, wherein broadcasting an alarm as a function of a change in the normal mode spectra comprises broadcasting the alarm as a function of an approach to a zero or unbounded value near the critical point.

7. The method of claim 6, wherein the approach to a zero or unbounded value comprises a change of greater than ten percent in an oscillation frequency or an oscillation period.

8. The method of claim 1, wherein broadcasting an alarm as a function of a change in the normal mode spectra comprises broadcasting the alarm as a function of an approach to an unbounded or zero slope of a frequency or period curve.

9. The method of claim 8, wherein the approach to a zero or unbounded slope comprises a change of greater than twenty percent in the slope of the frequency or period curve.

10. The method of claim 1, wherein broadcasting an alarm as a function of a change in the normal mode spectrum comprises broadcasting the alarm as a function of a deviation from an analytical model of the natural oscillation.

11. The method of claim 1, wherein the deviation from the analytical model comprises a deviation of at least three sigma in a frequency, a period or a slope, as compared to the analytical model.

12. The method of claim 1, wherein measuring physical parameters associated with natural oscillations of the structure comprises measuring physical parameters associated with natural oscillations of a bridge.

13. The method of claim 12, wherein broadcasting an alarm comprises directing traffic to stay off the bridge.

14. A method for warning of impending structural collapse, the method comprising:
measuring physical quantities associated with subsonic modes of oscillation in a structure subject to a mechanical load;
transforming the measured physical quantities into a normal mode spectrum, wherein the normal mode spectrum characterizes the subsonic modes of oscillation; and
transmitting a warning of impending collapse, wherein the warning is a function of a shift in the normal mode spectrum near a critical point.

15. The method of claim 14, wherein transmitting the warning of impending collapse is a function of a shift toward zero frequency in one of the subsonic modes of oscillation.

16. The method of claim 14, wherein transmitting the warning of impending collapse is a function of a shift toward a zero slope in one of the subsonic modes of oscillation.

17. The method of claim 14, wherein transmitting the warning of impending collapse is a function of a shift toward an undefined slope in one of the subsonic modes of oscillation.

18. The method of claim 14, wherein transforming the measured physical quantities into the normal mode spectrum comprises transforming the physical quantities such that the normal mode spectrum characterizes a fundamental mode of oscillation.

19. The method of claim 18, wherein transmitting the warning of impending collapse comprises transmitting the warning to emergency response personnel in order to evacuate the structure.

20. The method of claim 18, wherein transmitting the warning of impending collapse comprises transmitting a warning signal to direct persons to evacuate the structure.

21. A system for detecting onset of structural failure in a structural element, the system comprising:
a sensor for sensing a physical parameter associated with a normal mode of natural oscillation in the structural element;
a signal processor for transforming the physical parameter into an oscillation function representing the normal mode; and
a transmitter for transmitting an alarm indicating the onset of structural failure based on a shift in the oscillation function as the oscillation approaches a critical point.

22. The system of claim 21, wherein the normal mode has an order of less then ten.

23. The system of claim 22, wherein the shift comprises a shift of greater than ten percent in a period or frequency of the oscillation function.

24. The system of claim 22, wherein the shift comprises a shift of greater than twenty percent in a slope of the oscillation function.

25. The system of claim 22, wherein the shift comprises a deviation of at least three sigma between the oscillation function and an analytical model of the normal mode.

26. The system of claim 21, wherein the shift in the oscillation function occurs before failure of local components of the structural element.

27. The system of claim 21, wherein the shift in the oscillation function is indicative of the onset of a buckling failure.
